(19) United States
(12) Patent Application Publication
(10) Pub. No.: US 2023/0379882 A1
(43) Pub. Date: Nov. 23, 2023

(54) PAGING METHOD AND TERMINAL DEVICE

(71) Applicant: Guangdong OPPO Mobile Telecommunications Corp., Ltd., Dongguan (CN)

(72) Inventors: Bingxue LENG, Dongguan (CN); Qianxi LU, Dongguan (CN)

(73) Assignee: Guangdong OPPO Mobile Telecommunications Corp., Ltd., Dongguan (CN)

(21) Appl. No.: 18/229,366

(22) Filed: Aug. 2, 2023

Related U.S. Application Data
(63) Continuation of application No. PCT/CN2021/085142, filed on Apr. 1, 2021.

(51) Int. Cl. H04W 68/02; H04W 76/28

(52) U.S. Cl. CPC H04W 68/02; H04W 76/28

(57) ABSTRACT

A paging method and a terminal device are provided. The method includes: a relay terminal monitoring a network paging message according to a paging frame (PF) and/or a paging occasion (PO) corresponding to a remote terminal, and sending the detected network paging message to the remote terminal.

### CROSS-REFERENCE TO RELATED APPLICATIONS

The present application is a continuation of International Application No. PCT/CN2021/085142, filed on Apr. 1, 2021, which is hereby incorporated by reference in its entirety.

### BACKGROUND

There are three main application scenarios for the paging in the New Radio (NR) system, namely, a paging initiated by a Core Network, a paging initiated by a base station (gNB) and a notification of system message update initiated by gNB. The Physical Downlink Control Channel (PDCCH) of the above three paging messages is scrambled with the public paging identity configured in the cell, namely, Paging-Radio Network Temporary Identity (P-RNTI). A plurality of Paging Records are contained in the paging message initiated by the Core Network and the paging message initiated by the gNB. In each Paging Record, a paging message for a specific UE is contained.

The UE can calculate the Paging Frame (PF) and Paging Occasion (PO) according to the following formula:

PF: (SFN+PF_offset)mod T=(T div N)*(UE_ID mod N).

The meanings of the parameters are shown as follows. SFN: representing the frame number of the radio frame in which PF is located; PF_offset: representing the offset of the radio frame; T: representing the paging cycle; N: representing the number of PFs in the paging cycle; UE_ID: representing the identity of the UE, which is equal to 5G-S-TMSI mod 1024; and PO: i_s=floor(UE_ID/N)mod Ns.

The paging cycle T is the shortest Discontinuous Reception (DRX) cycle from network (RRC) messages, system messages or upper layers. Other parameters come from a system message.

In Rel-13 ProSe, UE-to-network relay function based on layer 3 relay is introduced. That is, a Remote UE is accessed to the network through a Relay UE. The Relay UE takes the function of the relay for IP layer, and data is transmitted between the Remote UE and the network. The Remote UE and the Relay UE are connected by a side link.

In Rel-15 FeD2D, 3GPP studies the UE-to-network relay function based on layer 2 relay. That is, the Remote UE is accessed to the network through the Relay UE. The Relay UE takes the function of the relay for the adaptive layer (above RLC layer and below PDCP layer), and data is transmitted between the Remote UE and the network. The Remote UE and the Relay UE are connected by a side link.

However, this part of the work has not been standardized subsequently.

### SUMMARY

The present disclosure relates to the field of communication, and more particularly to paging methods and terminal devices.

In the paging method and the terminal device of the embodiments of the present disclosure, the Relay UE can monitor the network paging message according to the PF and/or PO corresponding to the Remote UE when it is necessary to relay the paging message from the network for the Remote UE.

The embodiment of the present disclosure provides a paging method. The method includes the following operations.

A relay terminal monitors a network paging message according to a PF and/or a PO corresponding to a remote terminal, and sends a monitored network paging message to the remote terminal.

The embodiment of the present disclosure further provides a paging method. The method includes the following operations.

A remote terminal sends a PF and/or a PO corresponding to the remote terminal to the relay terminal, or sends information for determining the PF and/or the PO corresponding to the remote terminal to the relay terminal.

The remote terminal receives a network paging message monitored according to the PF and/or PO corresponding to the remote terminal from the relay terminal.

The embodiment of the present disclosure further provides a terminal device. The terminal device includes a monitoring module and a paging message sending module.

The monitoring module is configured to monitor a network paging message according to a PF and/or a PO corresponding to a remote terminal.

The paging message sending module is configured to send the monitored network paging message to the remote terminal.

The embodiment of the present disclosure further provides a terminal device. The terminal device includes a sending module and a paging message receiving module.

The sending module is configured to send a PF and/or a PO corresponding to the terminal device to a relay terminal, or send information for determining the PF and/or PO corresponding to the terminal device.

The paging message receiving module is configured to receive a network paging message monitored according to the PF and/or PO corresponding to the terminal device from the relay terminal.

The embodiment of the present disclosure further provides a terminal device. The terminal device includes a processor and a memory. The memory is configured to store a computer program, and the processor is configured to invoke and run the computer program stored in the memory to perform the method as described in any one of the above.

The embodiment of the present disclosure further provides a chip. The chip includes a processor. The processor is configured to invoke and run a computer program from a memory to cause a device on which the chip is mounted to perform the method as described in any one of the above.

The embodiment of the present disclosure further provides a computer-readable storage medium for storing a computer program that causes a computer to perform the method as described in any one of the above.

The embodiment of the present disclosure further provides a computer program product including computer program instructions that cause a computer to perform the method as described in any one of the above.

The embodiment of the present disclosure further provides a computer program that causes a computer to perform the method as described in any one of the above.

### BRIEF DESCRIPTION OF THE DRAWINGS

FIG. 1 is a schematic diagram of an application scenario of the embodiments of the present disclosure.

FIG. 2 is a schematic flow diagram of a paging method 200 according to the embodiments of the present disclosure.

FIG. 3 is an implementation flow chart of the first embodiment of the present disclosure.

FIG. 4 is an implementation flow chart of the second embodiment of the present disclosure.

FIG. 5 is an implementation flow chart of the third embodiment of the present disclosure.

FIG. 6 is an implementation flow chart of the fourth embodiment of the present disclosure.

FIG. 7 is a schematic flow diagram of a paging method 700 according to the embodiments of the present disclosure.

FIG. 8 is a schematic structural diagram of the terminal device 800 according to the embodiments of the present disclosure.

FIG. 9 is a schematic structural diagram of a terminal device 900 according to the embodiments of the present disclosure.

FIG. 10 is a schematic structural diagram of a terminal device 1000 according to the embodiments of the present disclosure.

FIG. 11 is a schematic structural diagram of a terminal device 1100 according to the embodiments of the present disclosure.

FIG. 12 is a schematic structural diagram of a communication device 1200 according to the embodiments of the present disclosure.

FIG. 13 is a schematic structural diagram of a chip 1300 according to the embodiments of the present disclosure.

### DETAILED DESCRIPTION

In the prior art, there is no relevant solution for how to realize the relay of the paging message from the network by the Relay UE for the Remote UE.

The embodiment of the present disclosure provides a solution when the relay terminal needs to relay the paging message from the network for the remote terminal. The relay terminal monitors the network paging message according to the PF and/or PO corresponding to the remote terminal, and sends a monitored message to the remote terminal, thus realizing the paging monitoring of the remote terminal.

The technical solutions in the embodiments of the present disclosure will be described below with reference to the drawings in the embodiments of the present disclosure.

It should be noted that the terms “first”, “second”, etc. in the description and claims of embodiments of the present disclosure and the above drawings are used to distinguish similar objects and are not used to describe a specific order or priority. The objects described in the “first” and “second” at the same time can be the same or different.

The technical solutions of the embodiments of the present disclosure may be applied to various communication systems, such as, Global System of Mobile communication (GSM) system, Code Division Multiple Access (CDMA) system, Wideband Code Division Multiple Access (WCDMA) system, General Packet Radio Service (GPRS), Long Term Evolution (LTE) system, Advanced long term evolution (LTE-A) system, New Radio (NR) system, evolution system of NR system, and LTE-based access to unlicensed spectrum (LTE-U) system, NR-based access to unlicensed spectrum (NR-U) system, Universal Mobile Telecommunications System (UMTS), Wireless Local Area Networks (WLAN), Wireless Fidelity (WiFi), 5th-Generation (5G) system or other communication systems.

In general, conventional communication systems support a limited number of connections and are easy to implement. However, with the development of communication technology, mobile communication systems will not only support conventional communication, but also support, for example, Device to Device (D2D) communication, Machine to Machine (M2M) communication, Machine Type Communication (MTC). Vehicle to Vehicle (V2V) communication, etc. Embodiments of the present disclosure may also be applied to these communication systems.

Alternatively, the communication system in the embodiments of the present disclosure may be applied to a Carrier Aggregation (CA) scenario, a Dual Connectivity (DC) scenario, and a Standalone (SA) network distribution scenario.

Embodiments of the present disclosure are not limited to the applied spectrum. For example, embodiments of the present disclosure may be applied to licensed spectrum or unlicensed spectrum.

Various embodiments of the present disclosure are described in connection with a network device and a terminal device. The terminal device may also be referred to as a User Equipment (UE), an access terminal, a subscriber unit, a subscriber station, a mobile station, a mobile stage, a remote station, a remote terminal, a mobile device, a user terminal, a terminal, a wireless communication device, a user agent or a user device, etc. The terminal device may be a STAION (ST) in a WLAN, a cellular telephone, a cordless telephone, a Session Initiation Protocol (SIP) telephone, a Wireless Local Loop (WLL) station, a Personal Digital Assistant (PDA) device, a handheld device having a wireless communication function, a computing device or other processing device connected to a wireless modem, a vehicle-mounted device, a wearable device, and a terminal device in a next generation communication system, such as a terminal device in an NR network or in a future evolved Public Land Mobile Network (PLMN) network.

By way of example and not limitation, in embodiments of the present disclosure, the terminal device may also be a wearable device. Wearable devices can also be called wearable intelligent devices, which are the general name of wearable devices developed by applying wearable technology to intelligently design daily wear, such as glasses, gloves, watches, clothing and shoes. Wearable device is a portable device that is worn directly on the body or integrated into the clothes or accessories of user. Wearable device is not only a kind of hardware device, but also realizes powerful functions through software support, data interaction and cloud interaction. Generalized wearable smart devices has features of full functions, large size and realizing complete or partial functions without relying on smart phones, such as smart watches or smart glasses, and a device which only focus on certain application functions, is used in conjunction with other devices such as smart phones, such as various smart bracelets for monitoring physical signs and smart jewelry.

The network device may be a device for communicating with a mobile device. The network device may be an Access Point (AP) in a WLAN, a Base Transceiver Station (BTS) in a GSM or CDMA, a base station (NodeB, NB) in a WCDMA, an Evolutional Node B, eNB or eNodeB in a LTE, a relay station or an Access Point, a vehicle-mounted device, a wearable device, a network device in a NR network (gNB) or a network device in a future evolved PLMN network, etc.

In the embodiments of the present disclosure, the network device provides services for the cell, and the terminal device communicates with the network device through the transmission resources (e.g. frequency domain resources, or spectrum resources) used by the cell. The cell may be a cell corresponding to the network device (e.g. base station), and the cell may belong to a macro base station or a base station corresponding to a Small cell. The Small cell may include a Metro cell, a Micro cell, a Pico cell, a Femto cell, etc. These Small cells have the characteristics of small coverage and low transmission power, and are suitable for providing high-speed data transmission services.

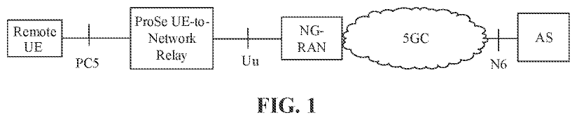

FIG. 1 illustrates a block diagram of a system 100 for relay transmission utilizing a relay function in a 5G network exemplarily. As shown in FIG. 1, the Remote UE may establish a direct connection with the Relay UE through an interface, and interact with the external network through the PDU session established between the relay UE and the 5G network.

It should be understood that the terms “system” and “network” are often used interchangeably herein. In the present disclosure, the term “and/or” is merely used for describing an association relationship that describes related objects, indicates that there may be three relationships, for example, A and/or B, which means that there are three situations: A exists alone, A and B exist simultaneously, and B exists alone. In addition, the character “/” in the present disclosure generally indicates that there is “or” relationship between the related objects.

It should be understood that the “indicating” mentioned in embodiments of the present disclosure may be a direct indication, may be an indirect indication, or may be indicative of an association. For example, A indicates B, which may mean that A directly indicates B, for example, B may be obtained through A. It may also mean that A indirectly indicates B, for example, A indicates C, and B may be obtained by C. It may also indicate that there is an association relationship between A and B.

In the description of embodiments of the present disclosure, the term “correspondence” may mean that there is a direct correspondence or an indirect correspondence between the two objects, may also mean that there is an association relationship between the two objects, may also be a relationship of indicating and being indicated, configuring and being configured, etc.

In order to facilitate understanding of the technical solutions of the embodiments of the present disclosure, the related technologies of the embodiments of the present disclosure are described in the following. The following related technologies may be arbitrarily combined with the technical solutions of the embodiments of the present disclosure as an optional scheme, all of which belong to the protection scope of the embodiments of the present disclosure.

Device to Device (D2D) communication is a Sidelink (SL) transmission technology based on D2D. Different from that the communication data is received or sent through the base station in the conventional cellular system, the vehicle to everything (V2X) system adopts the Terminal to Terminal direct communication mode. Therefore, is the V2X system has higher spectrum efficiency and lower transmission delay. Two transmission modes are defined in 3GPP: Mode A and Mode B.

In the Mode A, the transmission resources of the terminal are allocated by the base station, and the terminal transmits data on the SL according to the resources allocated by the base station. In the Mode A, the base station may allocate resources for single transmission or semi-static transmission to the terminal. In the Mode B, the vehicle-mounted terminal selects a resource in the resource pool for data transmission.

In 3GPP, D2D is divided into the following different stages for study.

The first stage, Proximity-based Service (ProSe): in Rel-12/13, D2D communication is studied for the ProSe scenario, which is mainly for public security services. In ProSe, the UE may send/receive data discontinuously on the SL by configuring the position of the resource pool in the time domain, for example, the resource pool is discontinuous in the time domain, thereby achieving the effect of saving power.

The second stage, the Vehicle to everything (V2X): in Rel-14/15, the V2X system is studied for the scenario of vehicle-vehicle communication, which is mainly for the services of vehicle-vehicle and vehicle-person communication with the relatively high-speed movement. In V2X, the power efficiency is not the main problem since the vehicle-mounted system is configured with the continuous supply of power, but the delay of data transmission is the main problem, so the terminal device is required to send and receive continuously in the system design.

The third stage, wearable devices (FeD2D): in Rel-14, the scenario of a wearable device accessing the network through mobile phone is studied, which is mainly aimed at the scenario of low movement speed and low power access. In FeD2D, 3GPP concluded that the base station may configure the DRX parameter of the Remote terminal through a Relay terminal in the pre-research stage, but there is no conclusion on the specific details of how to configure the DRX.

On the basis of LTE V2X, NR V2X is not limited to broadcast scenarios, but further extended to unicast and multicast scenarios, and in these scenarios, the application of V2X is studied. Similar to LTE V2X, in NR V2X, two resource grant modes are defined. Furthermore, a user may be in a mixed mode, that is, the user may use mode 1 for resource acquisition, and use mode-2 for resource acquisition at the same time. The resource acquisition is indicated by the way of SL grant, that is, the time-frequency positions of the corresponding PSCCH and PSSCH resources are indicated in the SL grant.

As mentioned in the above, in the paging scenario of the NR system, a plurality of Paging Records are contained in the paging message initiated by the Core Network and the paging message initiated by the gNB. Each Paging Record contains a paging message for a specific UE. The UE calculates PF and PO according to a predetermined formula, and monitors a paging message using the PF and the PO. In the SL relay technology, there is no related solution in the prior art for how the Relay UE relays the paging message from the network for the Remote UE.

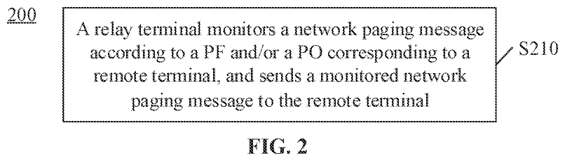

The embodiments of the present disclosure provide a paging method. FIG. 2 is a schematic flowchart of a paging method 200 according to the embodiments of the present disclosure. Optionally, the method is applied to the system shown in FIG. 1, such as the Relay terminal in FIG. 1, but is not limited thereto. The method includes at least part of the following contents.

In operation S210, a relay terminal monitors a network paging message according to a PF and/or a PO corresponding to a remote terminal, and sends a monitored network paging message to the remote terminal.

The relay terminal can monitor the paging message sent by the network side to the remote terminal by monitoring the paging message of the network side according to the PF and/or PO corresponding to the remote terminal, thereby solving the problem of paging the remote terminal in the SL relay system.

The PF and/or PO corresponding to the remote terminal may be calculated by the remote terminal and notified to the relay terminal, and may also be calculated by the relay terminal. For the above two different cases, the following embodiments are used for detailed introduction.

### Embodiment 1

In this embodiment, the PF and/or PO are calculated by the Remote UE and informed to the Relay UE directly. Since the calculation of the PF and/or the PO requires the use of the relevant configuration in the system message, the Relay UE may receive the system message and send the system message to the Remote UE. After that, the Relay UE may receive the PF and/or PO corresponding to the Remote UE from the Remote UE, and use the PF and/or PO corresponding to the Remote UE to monitor the network paging message later.

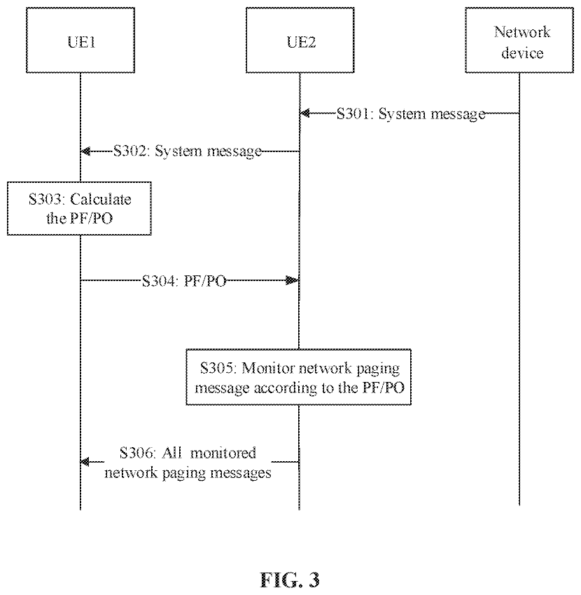

FIG. 3 is an implementation flowchart of the first embodiment of the present disclosure. In FIG. 3, a Remote UE is denoted by UE 1, and a Relay UE is denoted by UE 2. As shown in FIG. 3, Embodiment 1 includes the following operations.

In operation S301, the UE 2 receives the system message from a network device. The system message may include a Master Information Block (MIB) and/or a System Information Block 1 (SIB 1).

In operation S302, the UE 2 sends the system message to the UE 1.

In operation S303, the UE 1 calculates the PF and/or PO of the UE 1 according to the identity of the UE 1, the DRX cycle and the relevant configuration in the system message. The identity of UE 1 may include 5G-System Architecture Evolution-Temporary Mobile Subscriber Identity (5G-S-TMSI) or Radio Network Temporary Identifier (RNTI).

In operation S304, the UE 1 sends the PF and/or PO of UE 1 to the UE 2.

In operation S305, the UE 2 monitors the network paging message according to the PF and/or PO of the UE 1. The network paging message may include a Radio Access Network (RAN) paging or a Core Network (CN) paging.

In operation S306, the UE 2 sends all monitored network paging messages to UE 1.

### Embodiment 2

In this embodiment, the PF and/or PO are calculated by the Remote UE and directly informed to the Relay UE. Since the calculation of the PF and/or the PO requires the use of the relevant configuration in the system message, the Relay UE may receive the system message and send the system message to the Remote UE. After that, the Relay UE may receive the PF and/or PO corresponding to the Remote UE from the Remote UE, and use the PF and/or PO corresponding to the Remote UE to monitor the network paging message. Further, the Remote UE may inform the Relay UE of all or part of the information in the identity of the Remote UE for the Relay UE to filter the monitored network paging messages, and send the network paging message of all or part of the information in the identity of the Remote UE (such as the network paging message containing all or part of the information in the identity of the Remote UE) to the Remote UE. Through this filtering mechanism, the number of network paging messages sent by the Relay UE to the Remote UE may be reduced.

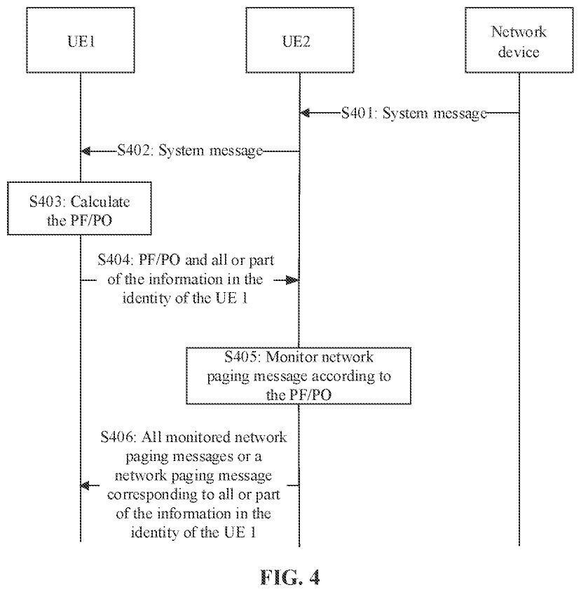

FIG. 4 is an implementation flowchart of the second embodiment of the present disclosure. In FIG. 4, the Remote UE is denoted by UE 1, and the Relay UE is denoted by UE 2. As shown in FIG. 4. Embodiment 2 includes the following operations.

In operation S401, the UE 2 receives the system message from the network device. The system message may include MIB and/or SIB 1.

In operation S402, the UE 2 sends the system message to the UE 1.

In operation S403, the UE 1 calculates the PF and/or PO of the UE 1 according to the identity of the UE 1, the DRX cycle and the relevant configuration in the system message. The identity of UE 1 may include 5G-S-TMSI or I-RNTI.

In operation S404, the UE 1 sends the PF and/or PO of the UE 1 to the UE 2 and sends all or part of the information in the identity of the UE 1 to the UE 2.

Optionally, the remote terminal (i.e. UE 1) may send all or part of the information in the identity of the remote terminal, and the relay terminal (i.e. UE 2) receives all or part of the information in the identity of the remote terminal from UE 1. The part of information may include the first N bits or the last M bits in the identity of the remote terminal, and N and M are positive integers.

For example, the length of 5G-S-TMSI is 48 bits, and the UE 1 sends the first 8 bits of 5G-S-TMSI of the UE 1 to the UE 2 for UE 2 to filter the monitored network paging messages. After the UE 2 filters the monitored network paging messages, the obtained network paging message contains the first 8 bits of 5G-S-TMSI of the UE 1, and these paging messages contain a network paging message that should be sent to the UE 1, and may contain a network paging message belonging to other terminal devices. After receiving the network paging message sent by the UE 2, the UE 1 can extract its own network paging message according to its own identity.

The above part of the information in the identity of the remote terminal is only an example, which is not limited in the present disclosure.

In operation S405, the UE 2 monitors the network paging message according to the PF and/or PO of the UE 1. The network paging message may include a RAN paging or a CN paging.

In operation S406, the UE 2 filters the monitored network paging messages, and sends a network paging message corresponding to all or part of the information in the identity of the UE 1 (such as a network paging message containing all or part of the information in the identity of the E 1) to the UE 1.

### Embodiment 3

In this embodiment, the PF and/or PO are calculated by the Relay UE according to the UE_ID of the Remote UE, the DRX cycle and the related configuration in the system message.

In some embodiments, the relay terminal receives the system message and receives the UE_ID of the remote terminal and DRX cycle from the remote terminal. The relay terminal determines the PF and/or PO corresponding to the remote terminal according to the UE_ID of the remote terminal, the DRX cycle and the relevant configuration in the system message.

The UE_ID is equal to the result of the remainder operation on 1024 by the identity of the remote terminal. The identity of the remote terminal may include 5G-S-TMSI or I-RNTI.

After the network paging message is monitored according to the PF and/or PO corresponding to the remote terminal, the relay terminal may send all monitored network paging messages to the remote terminal.

Optionally, the relay terminal may filter the monitored network paging messages to send part of the monitored network paging messages to the remote terminal. Since the UE_ID reported by the remote terminal carries a part of the information of the identity of the remote terminal, the relay terminal may filter the monitored network paging messages by using the UE_ID reported by the remote terminal, and send the network paging message corresponding to the UE_ID of the remote terminal in the monitored network paging messages to the remote terminal.

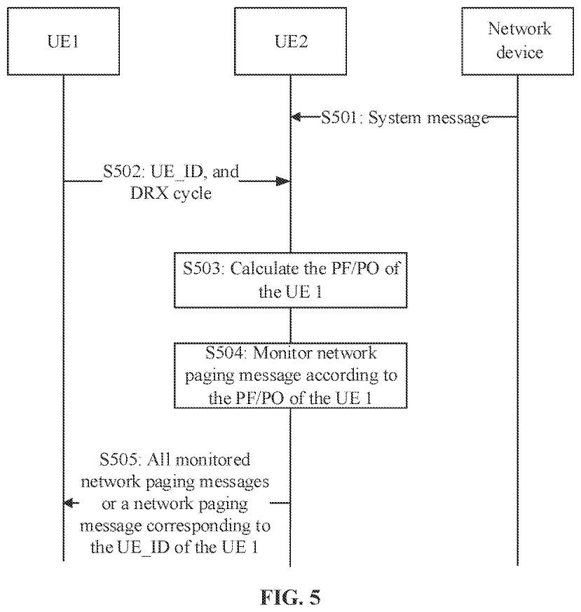

FIG. 5 is an implementation flowchart of the third embodiment of the present disclosure. In FIG. 5, a Remote UE is denoted by UE 1, and a Relay UE is denoted by UE 2. As shown in FIG. 5, Embodiment 3 includes the following operations.

In operation S501, the UE 2 receives a system message from a network device. The system message may include MIB and/or SIB 1.

In operation S502, the UE 2 receives the UE_ID of the UE 1 and the DRX cycle configured by the upper layer or the RRC from the UE 1. Optionally, the UE_ID of UE 1 is equal to the result of the remainder operation (mod) on 1024 by 5G-S-TMSI or I-RNTI of UE 1.

The above operations S501 and S502 are not limited in the order of execution.

In operation S503, the UE 2 calculates the PF and/or PO of the UE 1 according to the UE_ID of the UE 1, the DRX cycle and the relevant configuration in the system message.

In operation S504, the UE 2 monitors the network paging message according to the PF and/or PO of the UE 1. The network paging message may include a RAN paging or a CN paging.

In operation S505, the UE 2 sends all monitored network paging messages to UE 1. Alternatively, the UE 2 filters the monitored network paging messages and sends the network paging message corresponding to the UE_ID of the UE 1 (such as the network paging message containing the UE_ID of the UE 1) to the UE 1.

Similar to the effect of the second embodiment, the network paging message subjected to filtering in operation S505 includes a network paging message that should be sent to the UE 1 and may contain network paging messages belonging to other terminal devices. After receiving the network paging message sent by the UE 2, the UE 1 can extract its own network paging message according to its own identity. Through this filtering mechanism, the number of network paging messages sent by the Relay UE to the Remote UE can be reduced.

### Embodiment 4

In this embodiment, the PF and/or PO are calculated by the Relay UE according to the identity of the Remote UE, the DRX cycle, and the relevant configuration in the system message.

In some embodiments, the relay terminal receives the system message and receives an identity of the remote terminal and a DRX cycle from the remote terminal. The relay terminal determines the PF and/or PO corresponding to the remote terminal according to the identity of the remote terminal, the DRX cycle and the relevant configuration in the system message.

The identity of the remote terminal may include 5G-S-TMSI or I-RNTI.

Since the relay terminal has obtained the identity information of the remote terminal, the network paging message may be filtered by using the identity information. For example, the network paging message corresponding to the identity of the remote terminal in the monitored network paging messages is sent to the remote terminal.

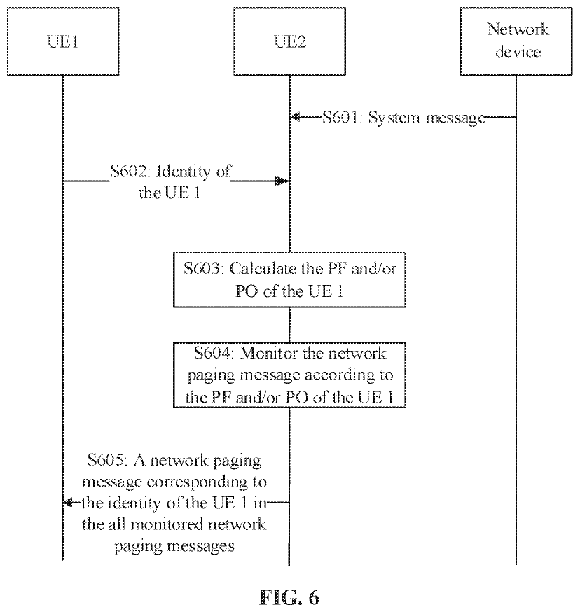

FIG. 6 is an implementation flowchart of the fourth embodiment of the present disclosure. In FIG. 6, a Remote UE is denoted by UE 1, and a Relay UE is denoted by UE 2. As shown in FIG. 6, Embodiment 4 includes the following operations.

In operation S601, the UE 2 receives a system message from a network device. The system message may include MIB and/or SIB 1.

In operation S602, the UE 2 receives the identity of the UE 1 and the DRX cycle configured by the upper layer or the RRC from the UE 1. Optionally, the identity of UE 1 includes 5G-S-TMSI or I-RNTI

The above operations S601 and S602 are not limited in the order of execution.

In operation S603, the UE 2 calculates the PF and/or PO of the UE 1 according to the identity of the UE 1, the DRX cycle and the relevant configuration in the system message.

In operation S604, the UE 2 monitors the network paging message according to the PF and/or PO of the UE 1. The network paging message may include a RAN paging or a CN paging.

In operation S605, the UE 2 sends a network paging message corresponding to the identity of the UE 1 (for example, a network paging message containing the identity of the UE 1) in all monitored network paging messages to the UE 1.

In operation S605, the identity of the UE 1 is used to accurately filter the network paging message, and the network paging message sent to the UE 1 after filtering only includes the network paging message that should be sent to the UE 1. Through this filtering mechanism, the number of network paging messages sent by the Relay UE to the Remote UE can be further reduced.

To sum up, according to the embodiments of the present disclosure, when the Relay UE needs to relay the paging message from the network for the Remote UE, the Relay UE acquires the PF and/or the PO of the Remote UE, and monitors the network paging message according to the acquired PF and/or the PO. Further, according to the present disclosure, the monitored network paging messages are filtered to reduce the number of paging messages sent by the Relay UE to the Remote UE and the related operations when the Remote UE receives the paging messages are simplified.

It should be noted that the above solutions can support all cases that the Remote UE is in an IDLE state (IDLE) and an INACTIVE state (INACTIVE), and the relay UE is in an IDLE state (IDLE), an INACTIVE state (INACTIVE) and a CONNECTED state (CONNECTED).

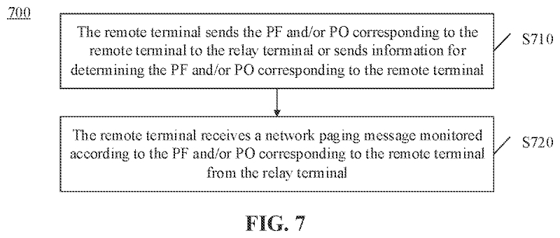

Embodiments of the present disclosure provide a paging method. FIG. 7 is a schematic flowchart of a paging method 700 according to the embodiments of the present disclosure. The method may be applied to the system shown in FIG. 1 optionally, such as to the remote terminal in FIG. 1, but is not limited thereto. The method includes at least part of the following operations.

In operation S710, the remote terminal sends the PF and/or PO corresponding to the remote terminal to the relay terminal or sends information for determining the PF and/or PO corresponding to the remote terminal.

In operation S720, the remote terminal receives, from the relay terminal, the network paging message monitored according to the PF and/or PO corresponding to the remote terminal.

In some embodiments, before the operation S710, the method may further include the following operations.

The remote terminal receives the system message from the relay terminal.

The remote terminal determines the PF and/or PO corresponding to the remote terminal according to the identity of the remote terminal, the DRX cycle and the relevant configuration in the system message.

In this manner, the remote terminal calculates the information of its own PF and/or PO, and sends the information of its own PF and/or PO to the relay terminal, and the relay terminal monitors the network paging message according to the information of the PF and/or PO.

Optionally, the network paging message received by the remote terminal from the relay terminal includes all network paging messages monitored by the relay terminal.

In some embodiments, the method may further include the following operation. The remote terminal sends all or part of the information in the identity of the remote terminal to the relay terminal. The identity may include 5G-S-TMSI or I-RNTI.

All or part of the information in the identity of the remote terminal sent by the remote terminal may be used for the relay terminal to filter the monitored network paging messages. Optionally, the network paging message received by the remote terminal from the relay terminal includes a network paging message corresponding to all or part of the information in the identity of the remote terminal in the network paging messages monitored by the relay terminal.

The part of the information in the identity of the remote terminal may include the first N bits or the last M bits in the identity of the remote terminal. N and M are positive integers.

In some embodiments, the above operation S710 may include the following operation. The remote terminal sends the UE_ID of the remote terminal and DRX cycle to the relay terminal. The UE_ID of the remote terminal may be equal to the result of the remainder operation on 1024 by the identity of the remote terminal (such as 5G-S-TMSI or I-RNTI).

In this manner, the relay terminal calculates the PF and/or PO information of the remote terminal, and monitors the network paging message according to the PF and/or PO information of the remote terminal. Further, the relay terminal may filter the monitored network paging messages by using the UE_ID of the remote terminal.

Optionally, the network paging message received by the remote terminal from the relay terminal includes all or part of the network paging messages monitored by the relay terminal.

The part of the network paging messages monitored by the relay terminal includes a network paging message corresponding to the UE_ID of a remote terminal in the network paging messages monitored by the relay terminal.

In some embodiments, the above operation S710 may include the following operation. The remote terminal sends the identity of the remote terminal and DRX cycle to the relay terminal. The identity of the remote terminal may include 5G-S-TMSI or I-RNTI.

In this manner, the relay terminal calculates the PF and/or PO information of the remote terminal, and monitors the network paging message according to the PF and/or PO information of the remote terminal. Further, the relay terminal may filter the monitored network paging messages by using the identity of the remote terminal.

Optionally, the network paging message received by the remote terminal from the relay terminal includes a network paging message, corresponding to the identity of the remote terminal, in the network paging messages monitored by the relay terminal.

In the above embodiments, the system message may include MIB and/or SIB 1.

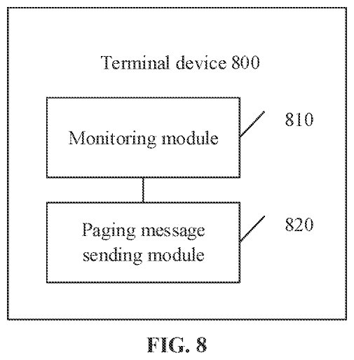

The embodiment of the present disclosure also provides a terminal device. The terminal device may be used as a relay terminal in the relay system. FIG. 8 is a schematic structural diagram of a terminal device 800 according to the embodiments of the present disclosure. The terminal device includes a monitoring module 810 and a paging message sending module 820.

The monitoring module 810 is configured to monitor a network paging message according to a PF and/or a PO corresponding to a remote terminal.

The paging message sending module 820 is configured to send a monitored network paging message to the remote terminal.

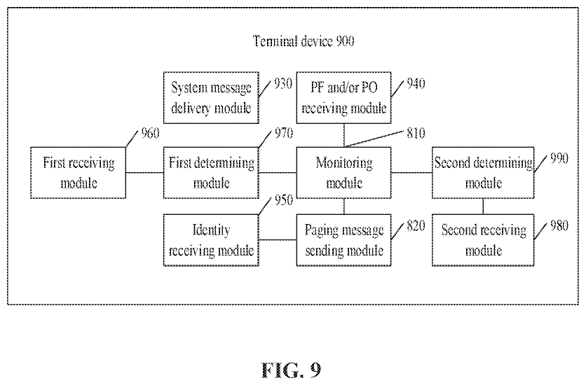

The embodiment of the present disclosure also provides a terminal device. FIG. 9 is a schematic diagram of the structure of the terminal device 900 according to the embodiments of the present disclosure. As shown in FIG. 9, the terminal device includes the monitoring module 810, the paging message sending module 820, and further includes a system message delivery module 930 and a PF and/or PO receiving module 940.

The system message delivery module 930 is configured to receive a system message and send the system message to the remote terminal.

The PF and/or PO receiving module 940 is configured to receive the PF and/or PO corresponding to the remote terminal from the remote terminal.

Optionally, the PF and/or PO corresponding to the remote terminal are/is determined by the remote terminal according to an identity of the remote terminal, a DRX cycle and a relevant configuration in the system message.

Optionally, the paging message sending module 820 is configured to send all monitored network paging messages to the remote terminal.

As shown in FIG. 9, optionally, the terminal device further includes an identity receiving module 950. The identity receiving module 950 is configured to receive all or part of information in the identity of the remote terminal from the remote terminal.

Optionally, the paging message sending module 820 is configured to send a network paging message, corresponding to all or part of the information in the identity of the remote terminal, in the monitored network paging messages, to the remote terminal.

Optionally, the part of the information in the identity of the remote terminal includes first N bits or the last M bits in the identity of the remote terminal. N and M are positive integers.

As shown in FIG. 9, optionally, the terminal device further includes a first receiving module 960 and a first determining module 970.

The first receiving module 960 is configured to receive a system message and receive an UE_ID of the remote terminal and a DRX cycle from the remote terminal.

The first determining module 970 is configured to determine the PF and/or PO corresponding to the remote terminal according to the UE_ID of the remote terminal, the DRX cycle and a relevant configuration in the system message.

Optionally, the paging message sending module 820 is configured to send all or part of monitored network paging messages to the remote terminal.

The part of the monitored network paging messages includes a network paging message, corresponding to the UE_ID of the remote terminal, in monitored network paging messages.

Optionally, the UE_ID of the remote terminal is equal to a result of a remainder operation on 1024 by the identity of the remote terminal.

As shown in FIG. 9, optionally, the terminal device further includes a second receiving module 980 and a second determining module 990.

The second receiving module 980 is configured to receive a system message and receive an identity of the remote terminal and a DRX cycle from the remote terminal.

The second determining module 990 is configured to determine the PF and/or PO corresponding to the remote terminal according to the identity of the remote terminal, the DRX cycle and the relevant configuration in the system message.

Optionally, the paging message sending module 820 is configured to send a network paging message, corresponding to the identity of the remote terminal, in monitored network paging messages, to the remote terminal.

Optionally, an identity of the remote terminal includes 5G-S-TMSI or RNTI.

Optionally, a system message includes a MIB and/or a SIB 1.

It should be understood that the above and other operations and/or functions of the above modules in the terminal device according to embodiments of the present disclosure are used for implementing the corresponding flow of the relay terminal in the method 200 of FIG. 2, which are not repeated here for the sake of brevity.

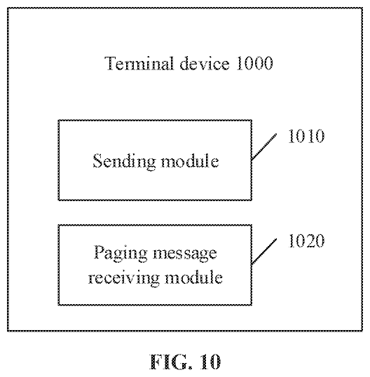

The embodiment of the present disclosure also provides a terminal device. The terminal device may be a remote terminal in the relay system. FIG. 10 is a schematic structural diagram of a terminal device 1000 according to the embodiments of the present disclosure. The terminal device includes a sending module 1010 and a paging message receiving module 1020.

The sending module 1010 is configured to send a PF and/or a PO corresponding to the terminal device to a relay terminal, or send information for determining the PF and/or PO corresponding to the terminal device to the relay terminal.

The paging message receiving module 1020 is configured to receive a network paging message monitored according to the PF and/or PO corresponding to the terminal device from the relay terminal.

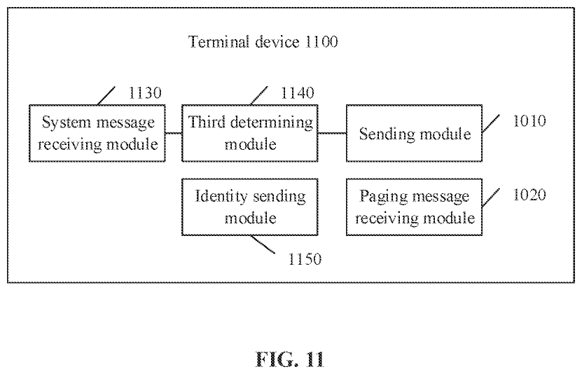

The embodiment of the present disclosure also provides a terminal device. FIG. 11 is a schematic structural diagram of a terminal device 1100 according to the embodiments of the present disclosure. As shown in FIG. 11, the terminal device includes the sending module 1010, the paging message receiving module 1020, and further includes a system message receiving module 1130 and a third determining module 1140.

The system message receiving module 1130 is configured to receive a system message from the relay terminal.

The third determining module 1140 is configured to determine the PF and/or PO corresponding to the terminal device according to an identity of the terminal device, a DRX cycle and a relevant configuration in the system message.

Optionally, the network paging message received by the paging message receiving module 1020 from the relay terminal includes all network paging messages monitored by the relay terminal.

As shown in FIG. 11, optionally, the terminal device further includes an identity sending module 1150.

The identity sending module 1150 is configured to send all or part of information in the identity of the terminal device to the relay terminal.

Optionally, the network paging message received by the paging message receiving module 1020 from the relay terminal includes a network paging message, corresponding to all or part of the information in the identity of the terminal device, in the network paging message monitored by the relay terminal.

Optionally, the part of the information in the identity of the terminal device includes first N bits or last M bits in the identity of the terminal device. N and M are positive integers.

Optionally, the sending module 1010 is configured to send an UE_ID of the terminal device and a DRX cycle to the relay terminal.

Optionally, the network paging message received by the paging message receiving module 1020 from the relay terminal includes all or part of the network paging messages monitored by the relay terminal.

The part of the network paging messages monitored by the relay terminal includes a network paging message, corresponding to UE_ID of the terminal device, in the monitored network paging messages.

Optionally, the UE_ID of the terminal device is equal to a result of a remainder operation on 1024 by the identity of the remote terminal.

Optionally, the sending module 1010 is configured to send an identity of the terminal device and a DRX cycle to the relay terminal.

Optionally, the network paging message received by the paging message receiving module 1020 from the relay terminal includes a network paging message, corresponding to the identity of the terminal device, in the network paging messages monitored by the relay terminal.

Optionally, an identity of the terminal device includes 5G-S-TMSI or I-RNTI.

Optionally, a system message includes a MIB and/or a SIB 1.

It should be understood that the above and other operations and/or functions of the above modules in the terminal device according to embodiments of the present disclosure are used for implementing the corresponding flow of the terminal device in the method 700 of FIG. 7, which are not repeated here for the sake of brevity.

It should be noted that the functions described by various modules (sub-module, unit or component, etc.) in the terminal device according to the embodiments of the present disclosure may be realized by different modules (sub-module, unit or component, etc.) or by a same module (sub-module, unit or component, etc.). For example, the first receiving module and the second receiving module may be different modules or a same module, which both can realize corresponding functions in the embodiments of the present disclosure. In addition, the sending module and the receiving module in the embodiments of the present disclosure may be realized by a transceiver of the device, and part or all of the remaining modules may be realized by a processor of the device.

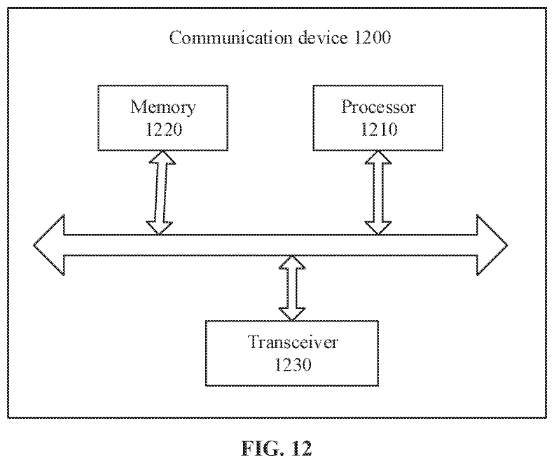

FIG. 12 is a schematic structural diagram of a communication device 1200 according to the embodiments of the present disclosure. The communication device 1200 shown in FIG. 12 includes a processor 1210. The processor 1210 is configured to invoke and run a computer program from a memory to implement the method in the embodiments of the present disclosure.

Optionally, as shown in FIG. 12, the communication device 1200 may further include a memory 1220. The processor 1210 may invoke and run a computer program from the memory 1220 to implement the method in the embodiments of the present disclosure.

The memory 1220 may be a separate device independent of the processor 1210 or may be integrated in the processor 1210.

Optionally, as shown in FIG. 12, the communication device 1200 may also include a transceiver 1230. The processor 1210 may control the transceiver 1230 to communicate with other devices. Specifically, the transceiver 1230 may send information or data to or receive information or data sent by other devices.

The transceiver 1230 may include a transmitter and a receiver. The transceiver 1230 may further include antennas, and the number of antennas may be one or more.

Optionally, the communication device 1200 may be a terminal device of the embodiments of the present disclosure, and the communication device 1200 may implement corresponding processes implemented by the terminal device in the various methods of the embodiments of the present disclosure, which will not be repeated here for the sake of brevity.

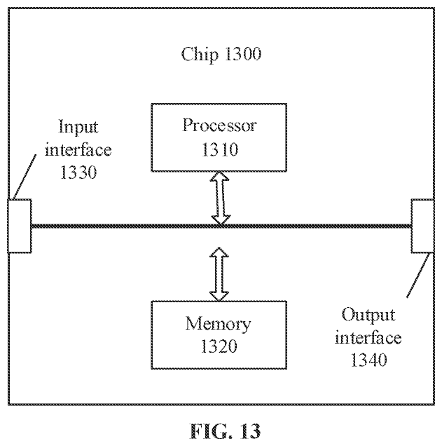

FIG. 13 is a schematic structural diagram of a chip 1300 according to the embodiments of the present disclosure. The chip 1300 shown in FIG. 13 includes a processor 1310. The processor 1310 is configured to invoke and run a computer program from memory to implement the method in the embodiments of the present disclosure.

Optionally, as shown in FIG. 13, the chip 1300 includes a memory 1320. The processor 1310 is configured to invoke and run a computer program from the memory 1320 to implement the method in the embodiments of the present disclosure.

The memory 1320 may be a separate device independent of the processor 1310 or may be integrated in the processor 1310.

Optionally, the chip 1300 may further include an input interface 1330. The processor 1310 may control the input interface 1330 to communicate with other devices or chips. Specifically, the input interface 1330 may obtain information or data sent by other devices or chips.

Optionally, the chip 1300 may further include an output interface 1340. The processor 1310 may control the output interface 1340 to communicate with other devices or chips. Specifically, the output interface 1340 may output information or data to other devices or chips.

Optionally, the chip may be applied to the terminal device in the embodiments of the present disclosure, and the chip may be configured to implement corresponding processes implemented by the terminal device in the respective methods of the embodiments of the present disclosure, which will not be repeated here for the sake of brevity.

Optionally, the chip may be applied to the network device in the embodiments of the present disclosure, and the chip may be configured to implement the corresponding processes implemented by the network device in the respective methods of the embodiments of the present disclosure, which will not be repeated here for the sake of brevity.

It should be understood that the chip mentioned in embodiments of the present disclosure may also be referred to as system level chip, system chip, chip system or chip-on system chip or the like.

The processor mentioned above may be a general purpose processor, a digital signal processor (DSP), a field programmable gate array (FPGA), an application specific integrated circuit (ASIC), or other programmable logic devices, transistor logic devices, discrete hardware components, and the like. The general purpose processor mentioned above may be a microprocessor or any conventional processor or the like.

The memory mentioned above may be a volatile memory or a non-volatile memory or may include both a volatile memory and a non-volatile memory. The non-volatile memory may be read-only memory (ROM), programmable ROM (PROM), erasable PROM (EPROM), electrically EPROM (EPROM) or flash memory. The volatile memory may be a random access memory (RAM).

It should be understood that the memory described above is exemplary, but not limiting, and, for example, the memory in embodiments of the present disclosure may also be static RAM (SRAM), dynamic RAM (DRAM), synchronous DRAM (SDRAM), double data rate SDRAM (DDR SDRAM), enhanced SDRAM (ESDRAM), synch link DRAM (SLDRAM), Direct Rambus RAM (DR RAM), etc. That is, the memory in embodiments of the present disclosure is intended to include but not limited to these and any other suitable types of memory.

The above embodiments may be implemented in whole or in part by software, hardware, firmware or any combination thereof. When implemented in software, they may be implemented in whole or in part in the form of a computer program product. The computer program product includes one or more computer instructions. When the computer program instructions are loaded and executed on a computer, the flow or function described in accordance with embodiments of the present disclosure is generated in whole or in part. The computer may be a general purpose computer, a special purpose computer, a computer network, or other programmable device. The computer instructions may be stored in or transmitted from one computer-readable storage medium to another computer-readable storage medium, for example, the computer instructions may be transmitted from one Web site, computer, server, or data center to another Web site, computer, server, or data center via wired (e.g. coaxial cable, optical fiber, Digital Subscriber Line (DSL)) or wireless (e.g. infrared, wireless, microwave, etc.). The computer-readable storage medium may be any usable medium accessible to a computer or a data storage device such as a server, data center, etc. containing integrated one or more usable medium. The usable medium may be magnetic medium (e.g. floppy disk, hard disk, magnetic tape), optical medium (e.g. DVD), or semiconductor medium (e.g. Solid State Disk (SSD)), etc.

It should be understood that in various embodiments of the present disclosure, the size of the sequence number of the above-mentioned processes does not mean the order of execution, and the execution orders of respective processes should be determined by their functions and inherent logics, and should not be limited in any way to the implementation process of the embodiments of the present disclosure.

Those skilled in the art will clearly appreciate that, for convenience and conciseness of description, the specific operating processes of the above-described systems, apparatuses and units may refer to the corresponding processes in the aforementioned method embodiments, which will not be repeated herein.

The above description is only the specific embodiments of the present disclosure, but the scope of protection of the present disclosure is not limited thereto. Any person skilled in the art who is familiar with the technical filed can easily think of changes or substitutions, which should cover within the scope of protection of the present disclosure. Therefore, the protection scope of the present disclosure should be subject to the protection scope of the claims.

1. A method for paging, comprising:
monitoring, by a relay terminal, a network paging message according to a Paging Frame (PF) and/or a Paging Occasion (PO) corresponding to a remote terminal; and
sending, by the relay terminal, a monitored network paging message to the remote terminal.

2. The method of claim 1, before monitoring the network paging message, further comprising:
receiving, by the relay terminal, a system message; and
sending, by the relay terminal, the system message to the remote terminal.

3. The method of claim 1, further comprising: before monitoring the network paging message,
receiving, by the relay terminal, a system message;
receiving, by the relay terminal, a UE_ID of the remote terminal and a DRX cycle from the remote terminal; and
determining, by the relay terminal, the PF and/or the PO corresponding to the remote terminal according to the UE_ID of the remote terminal, the DRX cycle and a relevant configuration in the system message.

4. The method of claim 3, wherein sending, by the relay terminal, the monitored network paging message to the remote terminal comprises:
sending, by the relay terminal, part of monitored network paging messages to the remote terminal,
wherein the part of the monitored network paging messages comprises a network paging message, corresponding to the UE_ID of the remote terminal, in the monitored network paging messages.

5. The method of claim 1, wherein an identity of the remote terminal comprises 5G-System Architecture Evolution-Temporary Mobile Subscriber Identity (5G-S-TMSI) or Radio Network Temporary Identifier (RNTI).

6. The method of claim 1, wherein the system message comprises a System Information Block 1 (SIB 1).

7. A method for paging, comprising:
sending, by a remote terminal, a Paging Frame (PF) and/or a Paging Occasion (PO) corresponding to the remote terminal to a relay terminal, or sending, by the remote terminal, information for determining the PF and/or PO corresponding to the remote terminal to the relay terminal; and
receiving, by the remote terminal, from the relay terminal, a network paging message monitored according to the PF and/or PO corresponding to the remote terminal.

8. The method of claim 7, before sending, by the remote terminal, the PF and/or the PO corresponding to the remote terminal to the relay terminal, further comprising:
receiving, by the remote terminal, a system message from the relay terminal.

9. The method of claim 7, wherein an identity of the remote terminal comprises 5G-System Architecture Evolution-Temporary Mobile Subscriber Identity (5G-S-TMSI) or Radio Network Temporary Identifier (RNTI).

10. The method of claim 7, wherein the system message comprises a System Information Block 1 (SIB 1).

11. A terminal device, comprising a processor and a memory, wherein the memory is configured to store a computer program, and the processor is configured to invoke and run the computer program stored in the memory to perform a method comprising:
monitoring a network paging message according to a Paging Frame (PF) and/or a Paging Occasion (PO) corresponding to a remote terminal; and
sending a monitored network paging message to the remote terminal.

12. The terminal device of claim 11, wherein before monitoring the network paging message, the method further comprises:
receiving a system message; and
sending the system message to the remote terminal.

13. The terminal device of claim 11, before monitoring the network paging message, the method further comprises:
receiving a system message and receiving a UE_ID of the remote terminal and a DRX cycle from the remote terminal; and
determining the PF and/or PO corresponding to the remote terminal according to the UE_ID of the remote terminal, the DRX cycle and a relevant configuration in the system message.

14. The terminal device of claim 13, wherein sending the monitored network paging message to the remote terminal comprises:
sending part of monitored network paging messages to the remote terminal,
wherein the part of the monitored network paging message comprises a network paging message, corresponding to the UE_ID of the remote terminal, in the monitored network paging messages.

15. The terminal device of claim 11, wherein an identity of the remote terminal comprises 5G-System Architecture Evolution-Temporary Mobile Subscriber Identity (5G-S-TMSI) or Radio Network Temporary Identifier (RNTI).

16. The terminal device of claim 11, wherein the system message comprises a System Information Block 1 (SIB 1).

17. A terminal device, comprising a processor and a memory, wherein the memory is configured to store a computer program, and the processor is configured to invoke and run the computer program stored in the memory to perform a method comprising:
sending a Paging Frame (PF) and/or a Paging Occasion (PO) corresponding to the terminal device to a relay terminal, or send information for determining the PF and/or PO corresponding to the terminal device to the relay terminal; and
receiving a network paging message monitored according to the PF and/or PO corresponding to the terminal device from the relay terminal.

18. The terminal device of claim 17, wherein before sending, the PF and/or the PO corresponding to the remote terminal to the relay terminal, the method further comprises:
receiving a system message from the relay terminal.

19. The terminal device of claim 17, wherein an identity of the terminal device comprises 5G-System Architecture Evolution-Temporary Mobile Subscriber Identity (5G-S-TMSI) or Radio Network Temporary Identifier (RNTI).

20. The terminal device of claim 17, wherein the system message comprises a System Information Block 1 (SIB 1).
